(19) United States
(12) Patent Application Publication
(10) Pub. No.: US 2017/0266945 A1
(43) Pub. Date: Sep. 21, 2017

(54) STRIPPING SYSTEM AND METHOD FOR LAMINATE CONSTRUCTIONS

(71) Applicant: JOHN HAZEN, SOUTH HADLEY, MA (US)

(72) Inventor: JOHN HAZEN, SOUTH HADLEY, MA (US)

(21) Appl. No.: 15/462,047

(22) Filed: Mar. 17, 2017

Related U.S. Application Data
(60) Provisional application No. 62/309,746, filed on Mar. 17, 2016.
(60) Provisional application No. 62/319,554, filed on Apr. 7, 2016.

(51) Int. Cl. B32B 43/00; B65H 23/26

(52) U.S. Cl. CPC B32B 43/006; B65H 23/26

(57) ABSTRACT

A movable material web assembly for use in conditioning a material web comprising a substrate layer and a protective layer covering the substrate layer comprising a first web transportation assembly selectively conveying said material web along an axis of movement via a material web roller; and a stripping roller oriented at an angle to said axis of movement, and is selectively engaged to strip away the protective layer as the material web is communicated along the axis of movement; and the stripping roller selectively strips the protective layer in a direction substantially orthogonal to the axis of movement.

### CROSS-REFERENCE TO RELATED APPLICATIONS

This application claims the benefit of U.S. Provisional Application Ser. No. 62/309,746 filed on Mar. 17, 2016, and U.S. Provisional Application Ser. No. 62/319,554 filed on Apr. 7, 2016 which are herein incorporated by reference in its entirety.

### FIELD OF THE INVENTION

This invention relates, generally, to a stripping system and method for laminate constructions, and, in particular, to a stripping system and method for paper substrate laminate constructions.

### BACKGROUND OF THE INVENTION

Paper substrate laminate constructions are utilized to provide greater performance and functionality than is possible with single-sheet paper. In general, the paper substrate laminate construction comprises two layers—the paper substrate for receiving deposition of ink printing, metallic printing, or embossing, a protective layer for protection the paper substrate. Indeed, depending on the specific layers of the laminate construction itself, it is possible to produce a paper substrate laminate construction that is more receptive to metallic depositions, including holographic imaging, as well as being more useful for digital printing and having ultra smooth surfaces.

In various processes, for either sheeting, printing, embossing, laminating, hot stamping, or the like, a protective layer needs to be stripped prior to continuing on to the next process. In some cases, this could be a laminated web—paper to film, paper board to film, film to film, foil to board, or foil to film. In other cases, a carrier or protective film is interleaved in between wraps on a roll to protect the product and prevent wraps from coming in contact with each other.

To separate a lamination or remove a protective layer, a rewind stand needs to be placed within an existing web path. This can prove to be cumbersome or impossible due to physical space constraints.

Moreover, known laminate constructions, however, suffer in both quality and performance due to contamination of the upper, printable or metallic receptive surface once the protective layer is removed.

It is therefore one object of the present invention to provide a stripping system and method for paper substrate laminate constructions which permits paper laminate constructions to be fabricated having a protective layer, which may thereafter be selectively stripped away to provide access to the printable or metallic deposition layers.

### SUMMARY OF THE INVENTION

The stripping system and method for paper substrate laminate constructions includes one or more turning bars or tables, located adjacent a material web of paper substrate laminate construction, so as to selectively strip away a protective layer immediately prior to a metal deposition, or digital printing, operation.

According to another object of the present invention, the stripping system and method for paper substrate laminate constructions may be placed in any number of structural configurations with respect to the material web of paper, including on the side of the primary axis of the moving stock, in order to promote space conservation and increased performance.

### BRIEF DESCRIPTION OF THE DRAWINGS

FIG. 1 is a perspective view of the stripping system and method for paper substrate laminate constructions, according to one embodiment of the present invention.

FIG. 2 is another view of the stripping system and method for paper substrate laminate constructions, as shown in FIG. 1.

FIG. 3 is yet another view of the stripping system and method for paper substrate laminate constructions, as shown in FIG. 1.

FIG. 4 is a perspective view of the stripping system and method for paper substrate laminate constructions with unwind stand and rewind stand, according to one embodiment of the present invention.

FIG. 5 is a perspective view of the stripping system and method for paper substrate laminate constructions illustrating the turn bar and a number of idle rollers, according to one embodiment of the present invention.

FIG. 6 is a top plan view of the stripping system and method for paper substrate laminate constructions, according to one embodiment of the present invention.

FIG. 7 is an enlarged perspective view of the stripping system and method for paper substrate laminate constructions illustrating the turn bar and a number of idle rollers, as shown in FIG. 4 according to one embodiment of the present invention.

FIG. 8 is an enlarged perspective view of the stripping system and method for paper substrate laminate constructions illustrating the turn bar, as shown in FIG. 7 according to one embodiment of the present invention.

### DETAILED DESCRIPTION OF THE PREFERRED EMBODIMENTS

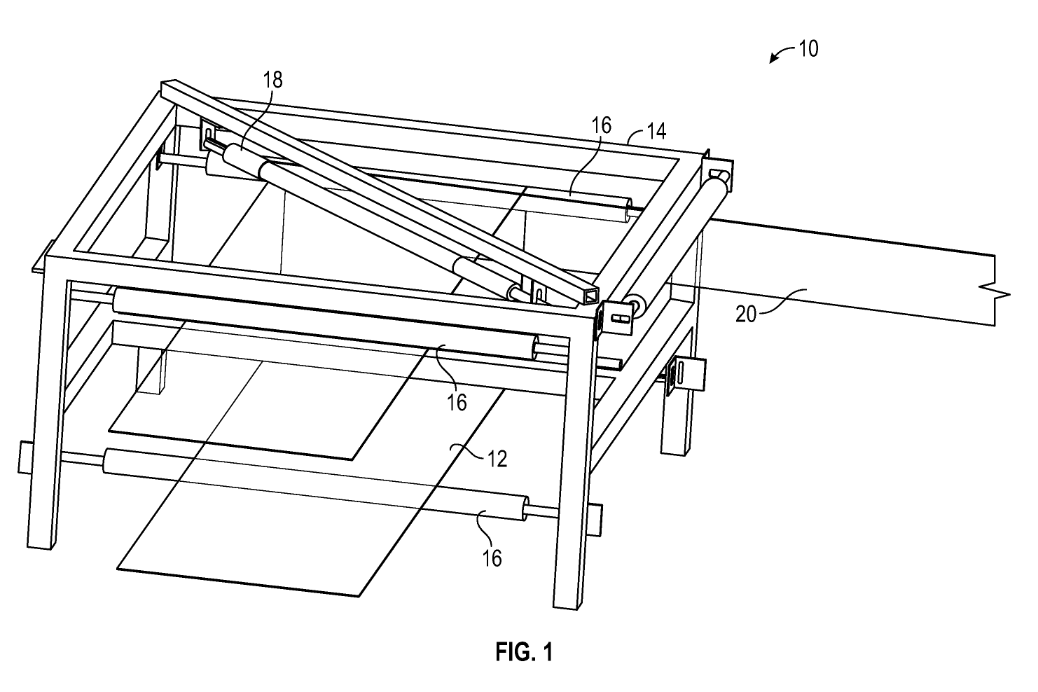

A stripping system/moveable material web assembly for paper substrate laminate constructions 10 is shown in FIG. 1, according to one embodiment of the present invention. The stripping system for paper substrate laminate constructions 10 includes a material web of paper/material web 12 (or other medium), as it moves along a web moving pathway through and within a frame assembly 14. A series of idler turn bars/material web roller 16 are utilized to guide the material web 12 through the frame assembly 14, as is generally known.

A specialized film turn bar/stripping roller 18 is arranged at an angle to the material web 12 so as to permit the stripping of a protective layer or film 20 from the paper substrate laminate construction, during movement of the material web 12.

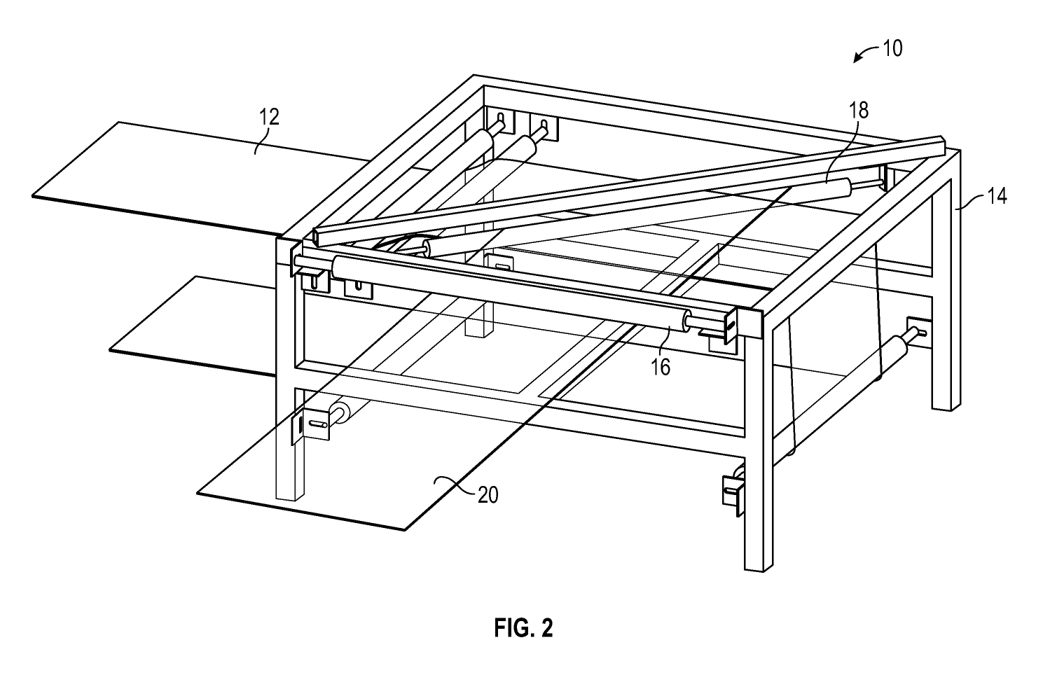

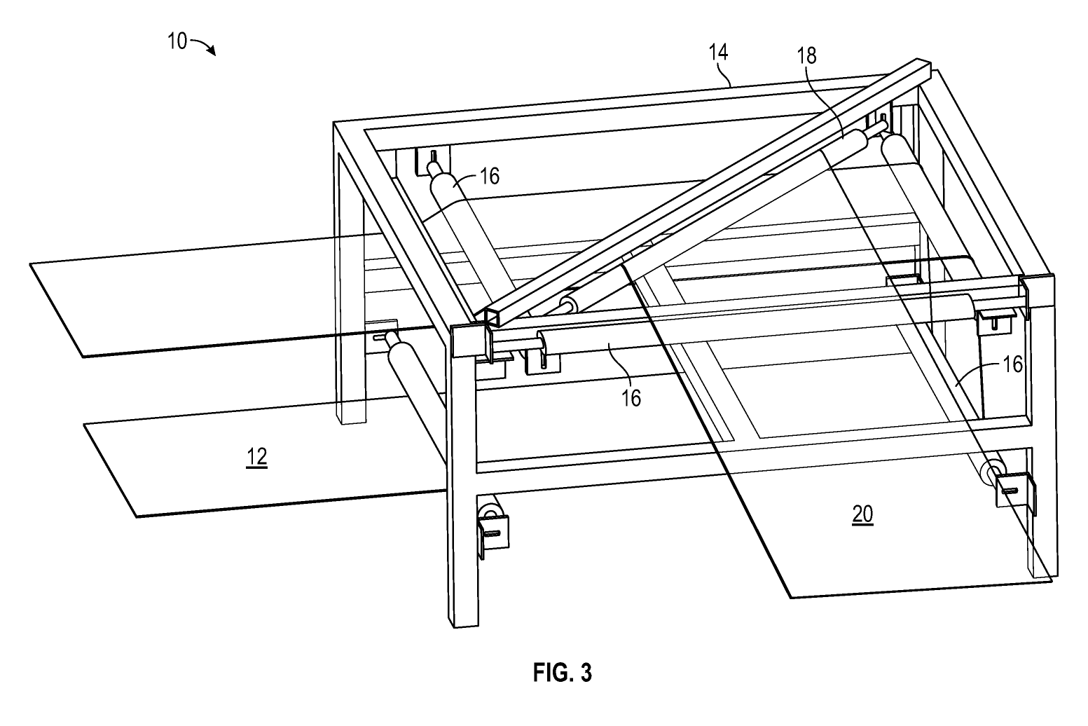

As perhaps best shown in FIGS. 2 and 3, by orienting the stripping roller 18, or bars, at an angle to the axis of movement of the material web 12, the present invention is capable to removing the protective film 20 from the material web 12 at, or in near time proximity, to the deposition of metallic inks, dies or formulations, or digital printing operations, thereby ensuring that all such printing or depositions are accomplished on pristine surfaces. It should be noted that the material web 12 can receive the deposition of ink printing, the deposition for metallic printing, or deposition of embossing.

As will also be appreciated, by utilizing the stripping roller 18, it is possible to orient the stripping system for laminate constructions to the side, rather than at a distal end of, the material web 12, thereby providing for greater space efficiency and performance.

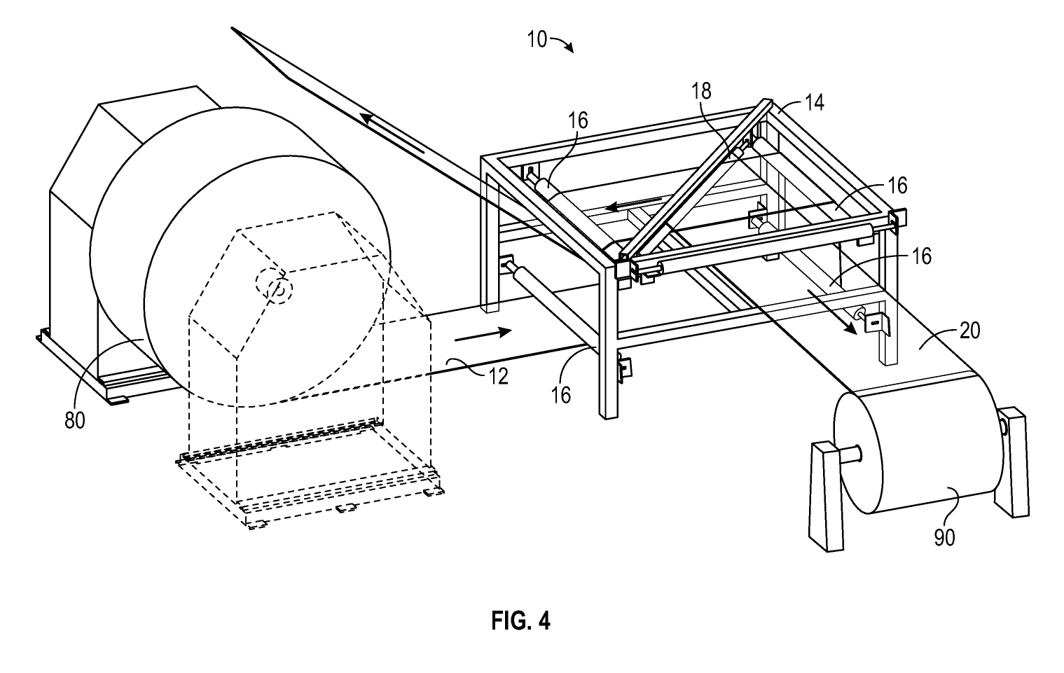

FIG. 4 shows a stripping system for paper substrate laminate constructions 10 in association with an unwind stand 80 and a rewind stand 90. In one embodiment, the material web 12 is unwound from the unwind stand, and moves through and within the frame assembly 14. Three idler turn bars 16 guide the material web 12 and convey it to a web stripping plane where the stripping roller 18 is arranged at an angle to the material web 12 so as to permit the stripping of a protective layer or film 20 from the paper substrate laminate construction, during movement of the material web 12. The stripped material web is then conveyed for further processing while the removed protective layer film 20 is then conveyed to a rewind stand 90.

The stripping roller 18 can be arranged either into an existing web pathway, or outside of an existing web pathway. After being stripped from the material web 12, the protective layer film 20 leaves the stripping assembly in a direction different from the moving direction of the material web 12. The angle between the moving direction of the material web 12 and the moving direction of the stripped protective layer film 20 is between 0-180 degree. In one embodiment of the present invention, the angle between the moving direction of the material web 12 and the moving direction of the stripped protective layer film 20 is between 5-165 degree. In a preferred embodiment, the angle between the moving direction of the material web 12 and the moving direction of the stripped protective layer film 20 is substantially 90 degree. Such an arrangement relieves the space constrain for the material web processing significantly.

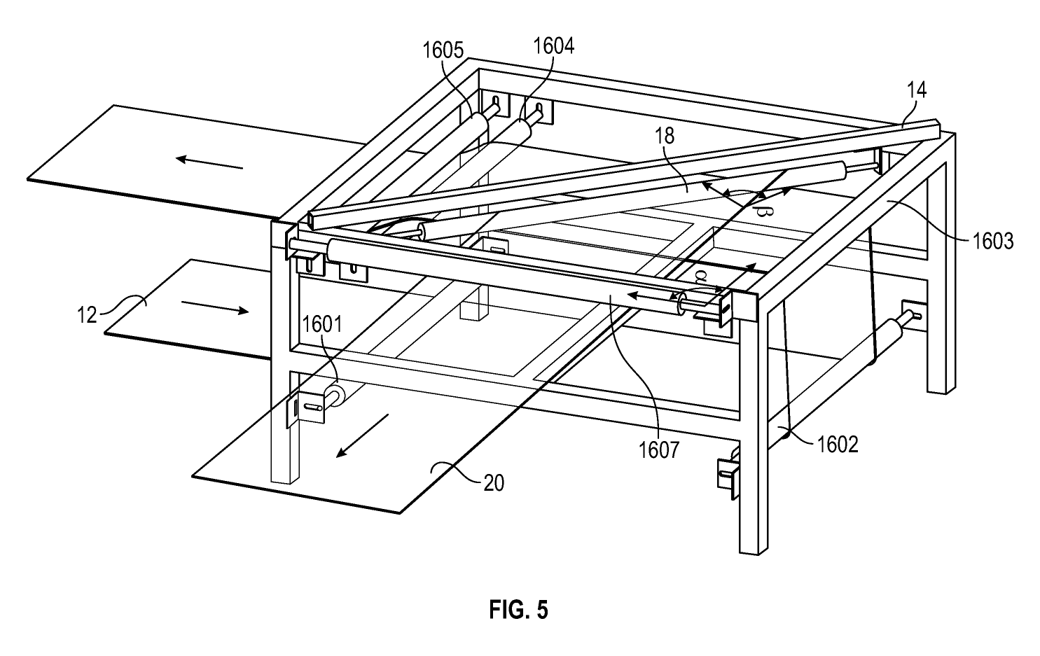

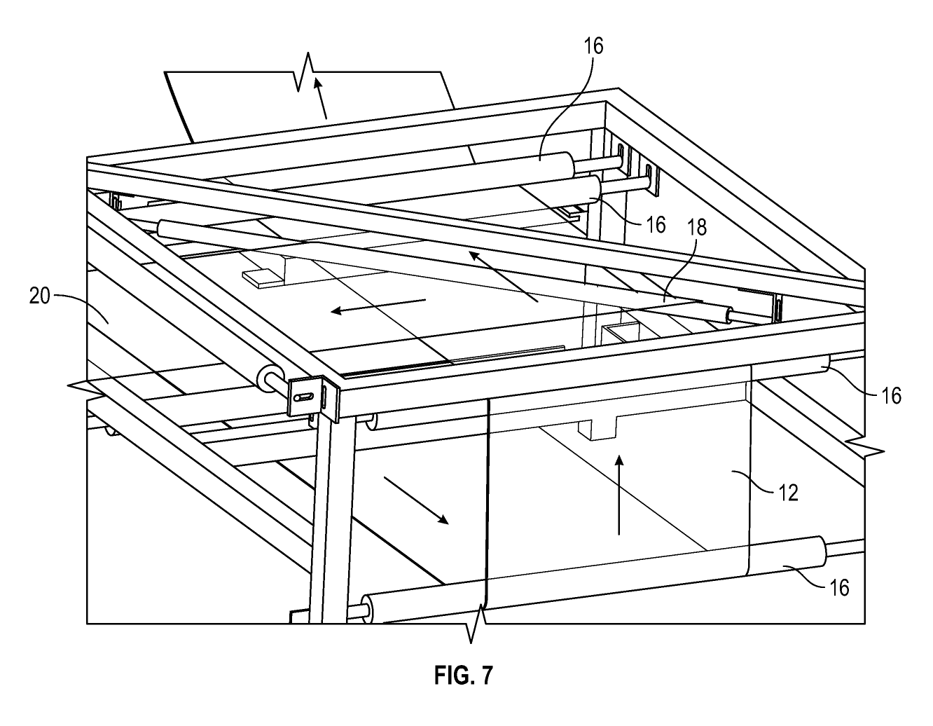

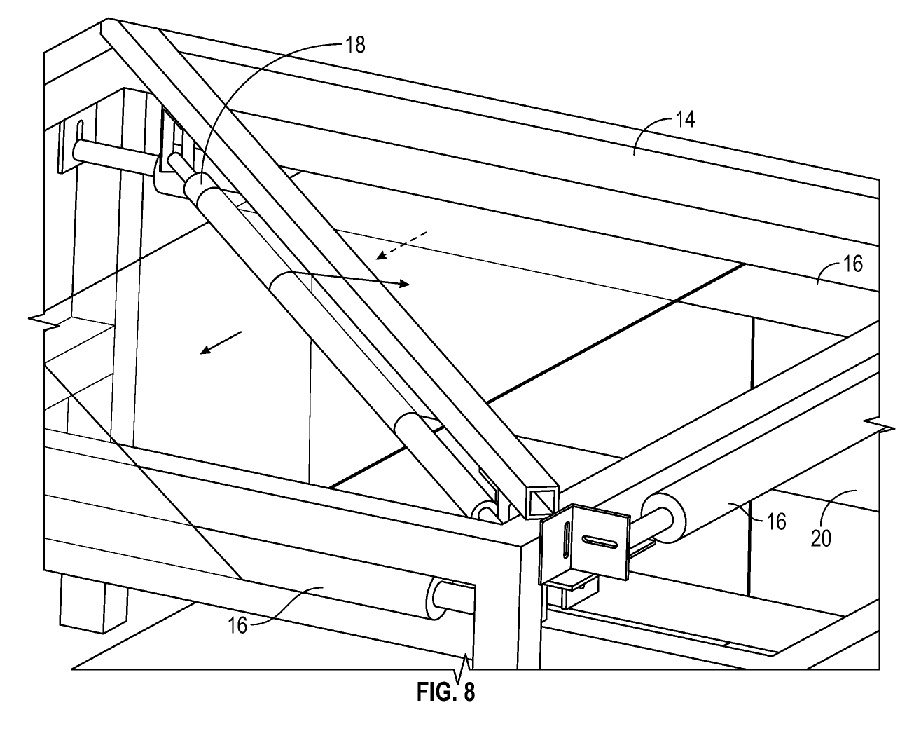

FIG. 5-8 illustrate one embodiment of present invention. In particular, a stripping system for paper substrate laminate constructions 10 comprises 7 idler turn bars 1601, 1602, 1603, 1604, 1605, 1607, and a stripping roller 18 mounted on one single frame assembly 14 or ease of portability. Five idler turn bars, 1601, 1602, 1603, 1604, and 1605, are parallel mounted on the frame assembly 14. The rotation axis of idler turn bars, 1601, 1602, 1603, 1604, and 1605 are substantially vertically to the moving direction of the material web 12. The stripping roller 18 can be either an idler bar or an adjustable turn bar. The stripping roller 18 directs the stripped protective layer film away from the moving stock. The moving direction of the material web 12 and the moving direction of the protective layer film 20 forms an angle a between 5-165 degree. In one embodiment, in which the angle a between the moving direction of the material web 12 and the moving direction of the protective layer film 20 is substantially 90 degree, the stripping roller is used as a guide roll.

It should be noted that the idler turn bar 1603, 1604, and the stripping roller 18 are all arranged in a web stripping plane, so that any excessive or loose tension on the stripped protective layer film 20 caused by the rewind stand 90 does not interfere with the angle a between the moving direction of the material web 12 and the moving direction of the protective layer film 20. In a case where angle α is 90°, the bottom face of idler turn bar 18 is also located on the web stripping plane.

The idler turn bar 1605 and 1607 remove any variabilities in the process so that the web stripping plane is unaffected by the height of previous and future turns bars incoming or going to the process, along with the height of the rewind stand 90 for the stripped protective layer film 20.

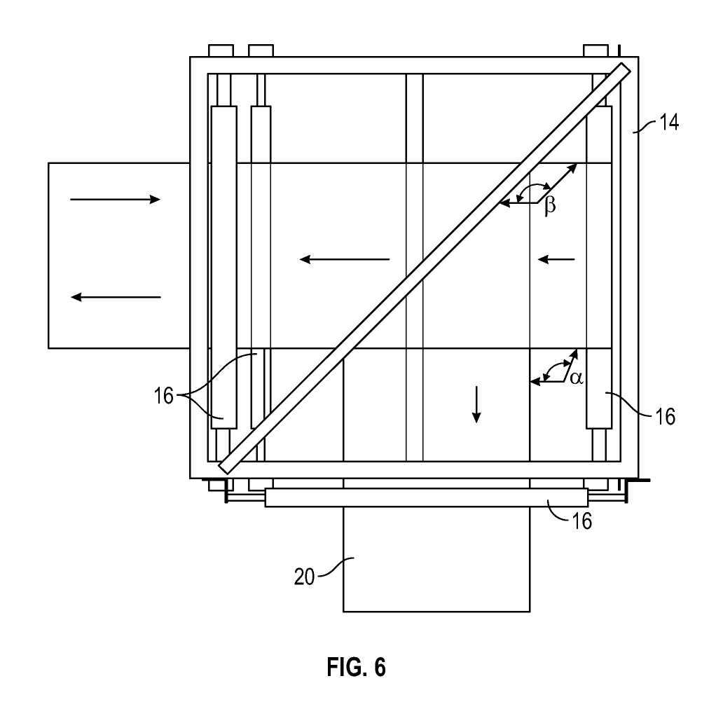

As shown in FIG. 6, the angle β is the angle between the rotation axis of the stripping roller 18 and the moving direction of the material web 12 in the web stripping plane. The relationship between the angle α and angle β is illustrated as follow:

α=(β−90°)×2

It should be noted that the stripping system 10 is moveable and can either be installed into an existing material web processing system, or be used as an end unit attached to an existing material processing system. The movability of the stripping system 10 provides machine stripping process in locations which are space constraint and therefore enhance its space efficiency.

In one embodiment in which the stripping system 10 is installed into an existing material web processing system, the material web 12 centers into the stripping system 10 through either idler turn bar 1602 or 1603. If the material web 12 enters into the stripping system 10 from a plane which is higher than the web stripping plane, the material web will enter the stripping system 10 via idler turn bar 1602 first. Therefrom, the material web 12 would enters into the web stripping plane via idler turn bar 1603. On the other hand, if the material web 12 enters into the stripping system 10 from a plane which is below the idler turn bar 1603, the material web would enter the web stripping plane via the top face of idler roll 1603.

With either web pathway, with the material web 12 is now on the top face of idler turn bar 1603, the material web 12 would therefrom proceed to stripping roller 18 and idler turn bar 1604. The protective layer film 20 would separate from the material web 12, curl around stripping roller 18 and be pulled towards the rewind stand 90 by means of the rewind stand, whether it be electric, pneumatic or hydraulic. The stripped material web would maintain its moving direction and be conveyed to the idler turn bar 1604, existing the stripping system under idler turn bar 1605, for any further process, whether it be sheeting, printing, embossing, laminating, hot stamping, or the like.

In another embodiment in which the stripping system 10 is installed outside an existing material web processing system, the stripping system 10 is designed so that the material web 12 can enter and leave from the same side of the stripping system 10, allowing for this stripping system to be installed at either end of a process. In such an embodiment, the material web 12 would enter the stripping system 10 under idler turn bar 1601 and moves through idler turn bars 1602 and 1603, where it would then enter the web stripping plane. It would then continue as mentioned above, with the 2 layers becoming separated at the stripping roller 18, which steers the stripped protective layer film 20 at an angle a towards its rewind stand.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A movable material web assembly for use in conditioning a material web comprising a substrate layer and a protective layer covering said substrate layer, said assembly comprising:
a first web transportation assembly, said web transportation assembly selectively conveying said material web along an axis of movement via a material web roller;
a stripping roller oriented at an angle to said axis of movement, wherein said stripping roller is selectively engaged to strip away said protective layer as said material web is communicated along said axis of movement; and
wherein said stripping roller selectively strips said protective layer in a direction substantially orthogonal to said axis of movement.

2. A movable material web assembly for use in conveying a material web comprising a substrate layer and a protective layer covering said substrate layer, said assembly comprising:
a first web transportation assembly, said web transportation assembly selectively conveying said material web along an axis of movement via a material web roller;
a stripping roller having an axis of rotation and being oriented at an angle to said axis of movement, wherein said stripping roller is selectively engaged to strip away said protective layer as said material web is communicated along said axis of movement; and
wherein said angle between said axis of rotation and said axis of movement is between 5 to 165 degrees.

3. A movable material web assembly for use in conveying a material web comprising a substrate layer and a protective layer covering said substrate layer, said assembly comprising:
a first web transportation assembly, said web transportation assembly selectively conveying said material web along an axis of movement;
a stripping roller having an axis of rotation and being oriented at an angle to said axis of movement, wherein said stripping roller is selectively engaged to strip away said protective layer as said material web is communicated along said axis of movement; and
wherein said angle between said axis of rotation and said axis of movement is between 75 to 105 degrees.
